(19) United States
(12) Patent Application Publication
(10) Pub. No.: US 2023/0060350 A1
(43) Pub. Date: Mar. 2, 2023

(54) BACTERICIDAL COMPOSITION FOR CONTROLLING GUMMY STEM BLIGHT OF MELONS

(71) Applicant: Institute of Plant Protection and Agro-products Safety, Anhui Academy of Agricultural Sciences, Hefei (CN)

(72) Inventors: Wei ZHAO, Hefei (CN); Rende QI, Hefei (CN); Yuankai CHI, Hefei (CN); A'mei XU, Hefei (CN); Yue MA, Hefei (CN); Shun CAO, Hefei (CN); Yanqiu HE, Hefei (CN)

(73) Assignee: Institute of Plant Protection and Agro-products Safety, Anhui Academy of Agricultural Sciences, Hefei (CN)

(21) Appl. No.: 17/981,480

(22) Filed: Nov. 7, 2022

(30) Foreign Application Priority Data
Feb. 27, 2022 (CN) 202210189354.X

(51) Int. Cl. A01N 43/78; A01N 43/56; A01P 3/00

(52) U.S. Cl. CPC A01N 43/78; A01N 43/56; A01P 3/00

(57) ABSTRACT

The present invention discloses a bactericidal composition for controlling gummy stem blight of melons. The bactericidal composition includes an active ingredient composed of Pydiflumetofen and Thifluzamide. An appropriate amount of agricultural bactericide adjuvant is added into the bactericidal composition to be prepared into a common agricultural bactericide dosage form. The two components in the present invention have no cross resistance. After combined according to a certain ratio, the two agents have an obvious synergistic effect, and have a more excellent effect of controlling fungal diseases of crops. Due to the combined use, the dose may be decreased; drug resistance of pathogenic bacteria to a single agent may be delayed; ecological damage and environmental pollution are effectively decreased; and crop yield and quality can be increased. The composition widens a disease resistance spectrum.

### TECHNICAL FIELD

The present invention belongs to field of agricultural bactericides, and particularly relates to a bactericidal composition of Pydiflumetofen and Thifluzamide. An agricultural bactericide is prepared by adding an appropriate amount of adjuvants, effectively controls gummy stem blight of melons and also controls common fungal diseases such as powdery mildew, leaf spot disease, brown spot and gray mold.

### BACKGROUND

Gummy stem blight is a fungal plant disease that widely exists throughout the world, and mainly harms Cucurbitaceae plants, including crops such as watermelons, muskmelons, cucumbers, Fructus trichosanthis and towel gourds. The disease may remain in diseased bodies in soil for a long time, may cause rapid infection under suitable climatic conditions and conduct large-area transmission and spread. It generally has an incidence rate of more than 50%, and may cause destructive losses in severe cases. In recent years, with the changes of farming modes and climatic conditions, yield and quality are blindly pursued in production. When the plant growth environment and crop growth are improved by facility greenhouses and water-fertilizer conditions, prevalence trend of the gummy stem blight is passively increased. Thus, the gummy stem blight becomes one of the most stubborn diseases of melon crops, which severely affects the yield and quality of the melons and restricts healthy development of the melon industry in China.

In recent years, through identification of molecular evolution levels, it is clear that pathogenic bacteria of gummy stem blight of Cucurbitaceae include three categories, such as Stagonosporopsis cucurbitacearum, Stagonosporopsis citrull and Stagonosporopsis caricae respectively. The three categories of pathogenic bacteria are similar in genetic relationship and basically consistent in morphology, and may harm most of the plants of the Cucurbitaceae. The pathogenic bacterium having the most common harm and the widest occurrence is the Stagonosporopsis cucurbitacearum. Primary infection pathogens of the gummy stem blight bacteria are ascospores remaining on the diseased bodies. The ascospores rapidly mature under suitable temperature and humidity conditions, may rapidly infect the plants after release, form lots of infection hypha in the plants, and form conidia for secondary infection. The pathogenic bacteria may conduct infection at the whole development stage of plant growth, and may harm different parts of the plants, such as stem, vine, leaf, flower and fruit. The stem, vine and leaf are the main pathogenic sites. Water stain-like small spots may appear at an early pathogenesis stage of the leaf, and gradually develop into wheel ring shaped yellowish brown spots or “V”-shaped disease spots at a later stage. Black dotted pycnidia may be observed at the pathogenic sites in severe cases. The pathogenesis is the most serious at the middle and later stages of plant growth. Water stain-like brown disease spots may appear at an early pathogenesis stage of the stem and vine parts. As the disease progresses, the disease spots may rapidly expand by several centimeters or even dozens of centimeters along the stem and vine. The fruits may be diseased when the gummy stem blight is severe; fruit rot is caused; and lots of hyphae grow on the fruits.

At present, the gummy stem blight of Trichosanthes kirilowii maxim is mainly controlled by a chemical agent. However, due to long-term use of a single agent and improper drug delivery modes, the pathogenic bacteria easily produce drug resistance. Thus, drug efficacy is decreased and disease outbreak is caused; medication is further increased; a vicious circle is formed; medication cost is increased; and environmental pollution is worsened, which is also a huge problem of chemical control. For example, Ascochyta citrullina strains that produce resistance to Azoxystrobin have appeared in partial areas. Therefore, searching a novel control agent and rationally compounding the novel control agent with pesticides having different chemical structures and different action mechanisms are effective measures of overcoming occurrence and development of the drug resistance. Meanwhile, the control effect may be enhanced; the dose in unit area is decreased; the aims of decreasing the drug and facilitating synergism are achieved; and a solution idea is provided for a contradictory problem between agricultural synergism and solving of agricultural non-point source pollution.

Pydiflumetofen is a phenyl-ethyl-pyrazol-aromatic amide succinic dehydrogenase inhibitor bactericide, and is a novel bactericide developed by Syngenta. It has a structural formula of (3-(difluoromethyl)-N-methoxy-1-methyl-N-[(RS)-1-methyl-2-(2,4,6-trichlorophenyl)ethyl]pyrazol-4-formamide), has a molecular formula of C₁₆H₁₆Cl₃F₂N₃O₂, and has a boiling point of 557.9° C.±50.0° C. and density of 1.44±0.1g/cm³. The Pydiflumetofen belongs to one of the compounds in succinic dehydrogenase inhibitors (SDHI), and interferes with respiration of plant pathogens by inhibiting activity of a complex enzyme II. The Pydiflumetofen has different bactericidal spectrums from other succinic dehydrogenase inhibitor bactericides, such as Thifluzamide, Fluopyram and Solatenol, and has no significant cross resistance to these bactericides, presumably because the Pydiflumetofen acts on different subunits of succinic dehydrogenase. The Pydiflumetofen is efficient, broad-spectrum and suitable for grains, corn, soybeans, oilseed rapes, vegetables, fruit trees, special crops, lawns and ornamental plants, and controls diseases caused by many pathogenic bacteria including Fusarium spp., Cercospora spp., Botrytis spp. and Alternaria spp., such as powdery mildew, leaf spot disease, brown spot, gray mold, gibberellic disease and stalk break. However, there is not report about a control effect of the Pydiflumetofen on the gummy stem blight at present.

Thifluzamide is a thiazole carboxyl N-benzamide efficient systemic bactericide and has strong systemicity and long persistence. An action mechanism of the Thifluzamide is the succinic dehydrogenase inhibitor. The agent has activity on pathogenic fungi such as Rhizoctonia, Puccinia, Ustilago, Tillefia, Corticium and Pyrenophora, and particularly has special effects on diseases caused by fungi of Basidiomycetes, such as banded sclerotial blight and wilt disease. The agent is safe to crops and hazard-free at a recommended dose, and may serve as a bactericide of cereal crops. However, the agent is high in use cost, and easily produces drug resistance when used alone.

### SUMMARY

The present invention provides two compounds having significant effects of controlling gummy stem blight of melons. The two compounds have no cross resistance, and have significant synergistic effects after combined according to a certain ratio. While increasing the control effect, the composition widens an anti-disease spectrum, and may control common diseases of melons, such as powdery mildew, leaf spot disease, early blight, brown spot, gray mold and blight caused by Fusarium.

Technical solutions of the present invention are as follows:

A bactericidal composition formula for controlling gummy stem blight of melons is provided. The bactericide is composed of Pydiflumetofen and Thifluzamide. Preferably, the bactericide is characterized in that a mass ratio of the Pydiflumetofen to the Thifluzamide is 20:1-1:20. When the bactericide is used for controlling southern blight of soybeans, the mass ratio of the Pydiflumetofen to the Thifluzamide is 5:1-1:5.

An active ingredient of the Pydiflumetofen and the Thifluzamide accounts for 1-80% of the total mass of the bactericidal composition. By adding an appropriate amount of agricultural bactericide adjuvant, the bactericidal composition is prepared into water suspension, wettable powder, microcapsules, water dispersible granules or suspended seed coatings, and simultaneously controls the common diseases of the melons, such as powdery mildew, leaf spot disease, early blight, brown spot, gray mold and blight caused by Fusarium.

Significant effects and advantages of the present invention are as follows:

The present invention first reports that the Pydiflumetofen has a significant control effect on the gummy stem blight; and the two compounds have different structure types and differential action sites and have significant synergistic effects after combined according to a certain ratio. The composition widens the anti-disease spectrum while increasing the control effect. By adding the efficient adjuvant, the composition is processed into suspension, wettable powder, microcapsules, water dispersible granules or suspended seed coatings that are easy to use in production. The composition is high in biological activity, widens the anti-disease spectrum, and has excellent control effects on frequently-occurring gummy stem blight of the melons and other common diseases in production. Moreover, the total dose in unit area is decreased after complex synergism; the medication frequency is decreased; drug delivery cost is decreased; occurrence and development of drug resistance of pathogens are delayed; the service life of various components in the bactericidal composition is prolonged; and the composition is high in crop safety, thereby achieving inventive purposes of economical efficiency, high efficiency and environmental protection.

### DETAILED DESCRIPTION OF THE EMBODIMENTS

The present invention will be further described below in combination with embodiments. However, contents of the present invention are not limited to the embodiments below.

Embodiment 1 Indoor toxicity test of Pydiflumetofen and the Thifluzamide on Stagonosporopsis cucurbitacearum

Bactericidal properties of the Pydiflumetofen and the Thifluzamide were analyzed in detail. EC50 (drug safety index) of two single components such as the Pydiflumetofen and the Thifluzamide (hereinafter referred to as agents) was tested first; a combination ratio of the two agents was set by a Wadley method according to the EC₅₀ of the two single agents, and according to a Wadley synergistic coefficient SR value.

A test object was Stagonosporopsis cucurbitacearum of melons, but was not limited herein. The Pydiflumetofen and the Thifluzamide were taken; a PDA solid medium was selected and prepared into a plate with drug liquid needs; each dish had a volume of about 18 ml; and hypha blocks having a diameter of 5 mm were prepared on the edges of pre-culture colonies by using a sterilized puncher and respectively transferred onto different medium plates to be cultured at 25° C. Hypha growth assay was adopted during the test; drug containing media were prepared according to different treatments; hypha blocks having a diameter of 5 mm were prepared on the edges of the pre-culture colonies by using the sterilized puncher and respectively transferred onto medium plates with different drug content; a colony diameter was tested by a crossing method; the colony diameter (mm) was measured; and a growth inhibition ratio was calculated by the following formula:

hypha growth inhibition ratio%=(1−(agent treatment colony diameter 5)/(control colony diameter 5)×100%

The hypha growth inhibition ratio was converted into an inhibition probability value (y); an agent concentration was converted into a concentration logarithm (x); a toxicity regression line was drawn by taking the concentration logarithm as a horizontal coordinate and taking the probability value as a vertical coordinate; toxic regression equations of the single agents such as the Pydiflumetofen and the Thifluzamide and a mixture thereof on the pathogenic bacteria were solved; and the EC₅₀ value and a correlation coefficient value r were calculated.

Interaction of the mixture was evaluated according to the Wadley method; and a calculation formula was as follows:

EC₅₀(theoretical value)=(a+b)/(a/EC₅₀a+b/EC₅₀b);

SR=EC₅₀ (theoretical value)/EC₅₀ (actual value).

In the formula, a and b were content ratios of various components in the mixture; and a mixing effect was analyzed based on the value SR. When SR≤0.5, the mixture of the two agents had antagonism; when SR=0.5-1.5, the mixture of the two agents had an addition effect; and when SR≥1.5, the mixture of the two agents had a synergistic effect.

TABLE 1
Toxicity test results of the single agents of the Pydiflumetofen and the Thifluzamide
and the mixture thereof on Stagonosporopsis cucurbitacearum

| | | | | EC₅₀ | |
|---|---|---|---|---|---|
| | | Correlation | EC₅₀ | (theoretical) | |
| Ratio (P:B) | Regression equation | coefficient (r) | ppm | ppm | SR |
| Pydiflumetofen (P) | y = 7.8972 + 1.4753x | 0.9919 | 0.0109 | | |
| Thifluzamide (B) | y = 6.7046 + 1.2667x | 0.9883 | 0.0451 | | |
| 15:1 | y = 7.6095 + 1.3758x | 0.998 | 0.0127 | 0.0114 | 0.8995 |
| 10:1 | y = 7.5778 + 1.3105x | 0.9944 | 0.0108 | 0.0117 | 1.0840 |
| 5:1 | y = 7.5628 + 1.2261x | 0.9879 | 0.0081 | 0.0125 | 1.5404 |
| 1:1 | y = 7.4857 + 1.2396x | 0.9876 | 0.0099 | 0.0176 | 1.7734 |
| 1:5 | y = 7.0222 + 1.1693x | 0.9787 | 0.0186 | 0.0296 | 1.5921 |
| 1:10 | y = 6.8054 + 1.1724x | 0.9942 | 0.0288 | 0.0351 | 1.2184 |

It can be seen from the above table that, the composition of the Pydiflumetofen and the Thifluzamide at different ratios had different bacteriostatic effects on the Stagonosporopsis cucurbitacearum. Experimental results showed that, the Pydiflumetofen and the Thifluzamide had the addition effect in a mass ratio range of 15:1-1:10, and had the synergistic effect in the ratio range of 5:1-1:5.

Indoor combined action determination results showed that, the composition of the Pydiflumetofen and the Thifluzamide has an excellent growth inhibition effect on the Stagonosporopsis cucurbitacearum. A significant synergistic effect exists between the two components. When compounded according to a certain ratio, the two components may decrease the dose and effectively decrease ecological damage and environmental pollution, and can improve yield and quality of the crops. In the present invention, both the Pydiflumetofen and the Thifluzamide have low toxicity and are safe to the people and livestock, beneficial organisms and the environment. The Pydiflumetofen and the Thifluzamide have no cross resistance and also have different bactericidal spectrums. When mixed in use, the two components may delay the drug resistance of the pathogenic bacteria on the single agents and widen the anti-disease spectrum of the crops, and achieve aims of control and drug decrease.

### Embodiment 2: Preparation Embodiments

### Preparation Embodiment 1

### Preparation Method of 18% Pydiflumetofen·Thifluzamide Water Dispersible Granules: in Percentage by Mass

15% of Pydiflumetofen, 3% of Thifluzamide, 6% of sodium lignin sulfonate, 4% of polyvinyl alcohol, 8% of ammonium sulfate, 10% of white carbon black and the balance of kaolin.

Preparation method: the above components were uniformly mixed in a mixer according to a formula ratio and then subjected to air jet pulverization; a small amount of purified water was added after completion of pulverization to fully and uniformly stir the components; and the mixture was subjected to extruding granulation and then dried, thereby obtaining the water dispersible granules.

### Preparation Embodiment 2

### Preparation Method of 20% Pydiflumetofen·Thifluzamide Suspension: in Percentage by Mass

10% of Pydiflumetofen, 10% of Thifluzamide, 6% of calcium lignosulphonate, 4% of alkyl phenol polyoxyethylene phosphate, 0.1% of xanthan gum, 0.3% of an organic silicon defoamer and the balance of water.

Preparation method: according to the formula, the above components were weighed according to a ratio; the components were ball-milled in a ball mill for 30 minutes and filtered; the components were extracted into a dispersing tank for high-speed shearing for 3 minutes and then fully ground by a sand mill; the diameter of solid component particles was controlled within 2 microns; and the components were uniformly stirred after completion of grinding, thereby obtaining the suspension.

### Preparation Embodiment 3

### Preparation method of 12% Pydiflumetofen·Thifluzamide Water Dispersible Granules: in Percentage by Mass

2% of Pydiflumetofen, 10% of Thifluzamide, 6% of sodium lignin sulfonate, 4% of polyvinyl alcohol, 8% of ammonium sulfate, 10% of white carbon black and the balance of kaolin.

Preparation method: the above components were uniformly mixed in a mixer according to a formula ratio and then subjected to air jet pulverization; a small amount of purified water was added after completion of pulverization to fully and uniformly stir the components; and the mixture was subjected to extruding granulation and then dried, thereby obtaining the water dispersible granules.

### Preparation Embodiment 4

Preparation method of 8% Pydiflumetofen·Thifluzamide suspended seed coatings: in percentage by mass.

4% of Pydiflumetofen, 4% of Thifluzamide, 3% of xanthan gum, 8% of a dispersing agent FS3000, 4% of 5-lauryl sodium sulfate, 3% of sodium lignin sulfonate, 3% of glycerol, 5% of bentonite, 2% of Dioctylsulfosuccinate sodium, 3% of a film-forming agent, 2% of a dye and the balance of water.

Preparation method: according to the formula, the above components (except for the film-forming agent and the dye) were weighed according to a ratio; the components were ball-milled in a ball mill for 60 minutes and filtered; the components were extracted into a dispersing tank for high-speed shearing for 3 minutes and then fully ground by a sand mill; the diameter of solid component particles was controlled within 1 μm; the components were uniformly stirred after completion of grinding; and the film-forming agent and the dye were added, thereby obtaining the suspended seed coatings.

### Embodiment 3: Field Control Experiment of Pydiflumetofen and the Thifluzamide on Gummy Stem Blight of Trichosanthes kirilowii maxim

Control tests of gummy stem blight of Trichosanthes kirilowii maxim were respectively conducted in 2020 and 2021. Test data in 2021 were collected as follows: the 20% Pydiflumetofen·Thifluzamide suspension, 20% Pydiflumetofen suspension, 30% Thifluzamide suspension and 25% Azoxystrobin suspension in embodiment 2 were respectively used in the experiment. The variety of the tested Trichosanthes kirilowii maxim was “Wanlou 9”; the test location was a Trichosanthes kirilowii maxim field in Gangji experimental production base in Anhui Academy of Agricultural Sciences; water consumption per mu was 30 kg; the Trichosanthes kirilowii maxim was subjected to agent control at an early stage of growing and flowering (May 20); and disease condition survey was conducted within 30 days (Table 2).

TABLE 2
Control effects of different compound dosage forms on the
gummy stem blight of Trichosanthes kirilowii maxim

| | | | | Disease |
|---|---|---|---|---|
| Control | | First dose | Incidence | control |
| object | Treatment agent | (g.a.i/ha) | rate (%) | effect (%) |
| Gummy stem | 20% | 150 | 2.88 | 93.18 |
| blight of | Pydiflumetofen · | | | |
| Trichosanthes | Thifluzamide | | | |
| kirilowii | suspension | | | |
| maxim | 20% Pydiflumetofen | 150 | 16.59 | 79.05 |
| | suspension | | | |
| | 30% Thifluzamide | 150 | 21.34 | 69.58 |
| | suspension | | | |
| | 25% Azoxystrobin | 150 | 39.64 | 55.25 |
| | suspension | | | |
| | Blank control | — | 62.27 | — |

Field experiment results showed that, the Pydiflumetofen and the Thifluzamide have significant control effects the on gummy stem blight of Trichosanthes kirilowii maxim, and have better control effects than the Azoxystrobin. A pesticide formulation combined according to a synergistic ratio has a more excellent overall control effect on the gummy stem blight of the Trichosanthes kirilowii maxim, and has the control effect higher than that of a single dosage form. According to field investigation, crop growth is normal in a test dose range; no plant has any disease or abnormal phenomena; and the pesticide formulation is safe to the Trichosanthes kirilowii maxim.

### Embodiment 4: Field Control Experiment of Pydiflumetofen and the Thifluzamide on Gummy Stem Blight of Watermelon

Control tests of gummy stem blight of watermelons were respectively conducted in 2020 and 2021. Test data in 2021 were collected as follows: the 18% Pydiflumetofen·Thifluzamide water dispersible granules, 20% Pydiflumetofen suspension, 30% Thifluzamide suspension and 25% Azoxystrobin suspension in embodiment 1 were respectively used in the experiment. The variety of the tested watermelon was “Zaojia 8424”; the test location was a watermelon greenhouse in Gangji experimental production base in Anhui Academy of Agricultural Sciences; water consumption per mu was 30 kg; the watermelons were subjected to agent control for the first time within 30 days after field planting of watermelon seedlings, and then subjected to agent control for the second time within 10 days after the first control; and disease condition survey was conducted within 30 days after the second agent control (Table 3).

TABLE 3
Control effects of different compound dosage forms
on the gummy stem blight of the watermelon

| | | | Second | | Disease |
|---|---|---|---|---|---|
| Control | | First dose | dose | Incidence | control |
| object | Treatment agent | (g.a.i/ha) | (g.a.i/ha) | rate (%) | effect (%) |
| Gummy stem | 18% | 120 | 100 | 1.85 | 94.18 |
| blight of the | Pydiflumetofen · | | | | |
| watermelon | Thifluzamide water | | | | |
| | dispersible granules | | | | |
| | 20% Pydiflumetofen | 120 | 100 | 13.08 | 80.25 |
| | suspension | | | | |
| | 30% Thifluzamide | 120 | 100 | 12.64 | 79.58 |
| | suspension | | | | |
| | 25% Azoxystrobin | 120 | 100 | 28.04 | 68.55 |
| | suspension | | | | |
| | Blank control | — | — | 63.08 | — |

Greenhouse experiment results showed that, the Pydiflumetofen and the Thifluzamide have significant control effects the on gummy stem blight of the watermelon, and have better control effects than the Azoxystrobin. A pesticide formulation combined according to a synergistic ratio has a more excellent overall control effect on the gummy stem blight of the watermelon, and has the control effect higher than that of a single dosage form. According to field investigation, crop growth is normal in a test dose range; no plant has any disease or abnormal phenomena; and the pesticide formulation is safe to the watermelon.

Finally, it should be noted that, the above listed examples are merely several specific embodiments of the present invention. Apparently, the present invention is not limited to the above embodiments, and may have many variations. All variations that can be directly derived or thought from the contents of the present invention by those ordinary skilled in the art are regarded as the protection scope of the present invention.

What is claimed is:

1. A bactericidal composition for controlling gummy stem blight of melons, wherein a bactericide is composed of Pydiflumetofen and Thifluzamide, and a mass ratio of the Pydiflumetofen to the Thifluzamide is 20:1-1:20.

2. The bactericidal composition according to claim 1, wherein the mass ratio of the Pydiflumetofen to the Thifluzamide is 5:1-1:5.

3. The bactericidal composition according to claim 1, wherein an active ingredient of the Pydiflumetofen and the Thifluzamide accounts for 1-80% of the total mass of the bactericidal composition; and by adding an appropriate amount of agricultural bactericide adjuvant, the bactericidal composition is prepared into suspension, wettable powder, microcapsules, water dispersible granules or suspended seed coatings.

4. The bactericidal composition according to claim 2, wherein an active ingredient of the Pydiflumetofen and the Thifluzamide accounts for 1-80% of the total mass of the bactericidal composition; and by adding an appropriate amount of agricultural bactericide adjuvant, the bactericidal composition is prepared into suspension, wettable powder, microcapsules, water dispersible granules or suspended seed coatings.

5. A use of the bactericidal composition of claim 1 in controlling gummy stem blight of melons, wherein the bactericidal composition simultaneously controls the fungal diseases of powdery mildew, leaf spot disease, brown spot or gray mold.
